(19) United States
(12) Patent Application Publication
(10) Pub. No.: US 2013/0214613 A1
(43) Pub. Date: Aug. 22, 2013

(54) SURFACE COMMUNICATION DEVICE

(71) Applicant: Naoki Kobayashi, Tokyo (JP)

(72) Inventor: Naoki Kobayashi, Tokyo (JP)

(73) Assignee: NEC CORPORATION, Minato-ku, Tokyo (JP)

(21) Appl. No.: 13/824,104

(22) PCT Filed: Sep. 14, 2011
(86) PCT No.: PCT/JP2011/070928

§ 371 Date: Apr. 5, 2013

(30) Foreign Application Priority Data
Oct. 8, 2010 (JP) 2010-228353

(51) Int. Cl. H02J 17/00

(52) U.S. Cl. CPC H02J 17/00
USPC 307/104

(57) ABSTRACT

A surface communication device includes: a sheet-shaped electromagnetic wave propagation unit that propagates electromagnetic waves; and a power supplying device unit or a power receiving device unit that is disposed above the electromagnetic wave propagation unit in a non-conductive state with the electromagnetic wave propagation unit, and includes an electromagnetic wave coupling unit that transmits electromagnetic waves to the electromagnetic wave propagation unit or receives electromagnetic waves from the electromagnetic wave propagation unit. The electromagnetic wave coupling unit includes a dielectric resonator that strengthens an electromagnetic coupling between the electromagnetic wave coupling unit and the electromagnetic wave propagation unit.

### TECHNICAL FIELD

The present invention relates to technology for wirelessly supplying electrical power. The present invention, in particular, relates to a surface communication device that supplies electrical power from a power supplying side to a sheet, or supplies electrical power from a sheet to a power receiving side such as a load.

### BACKGROUND ART

As a means of wirelessly supplying electrical power by communication using electromagnetic waves, there exists a system in which a power supplying device and a power receiving device are each arranged in a non-conducting manner on a sheet-shaped communication medium, and the electrical power that is wirelessly supplied from the power supplying device is wirelessly received at the power receiving device side via the sheet-shaped communication medium.

As a modified example of this kind of wireless power supply, there is also a system that performs power supply from a power supplying device to a communication medium by contact power supply, and performs power receiving from the communication medium to a power receiving device wirelessly. Moreover, as a modified example of that, a system that performs power supply from a power supplying device to a communication medium by wireless power supply, and performs power supply from the communication medium to a power receiving device by contact power supply is also envisaged as a future range of application.

This kind of communication means given above, including the modified examples, is referred to hereinbelow as surface communication.

Surface communication enables communication between two arbitrary points on a two-dimensional sheet, or the performing of either one of transmission or reception of electrical power between arbitrary points on a sheet.

Patent Documents 1 to 3 disclose technology relating to this kind of wireless power supply.

The power supply system that is shown in Patent Document 1 includes an electromagnetic wave propagation device that is constituted in a sheet shape and propagates electromagnetic waves, and a power supplying device that outputs electromagnetic waves to the electromagnetic wave propagation device. A plurality of electrodes that output electromagnetic waves to the electromagnetic wave propagation device are arranged in an array on a substrate at the lower surface of the power supplying device.

The electromagnetic wave interface device shown in Patent Document 2 supplies or receives electrical power to/from an electromagnetic wave transmission medium that has a mesh-shaped electrode. This electromagnetic wave interface device is constituted from a first conductor with a spiral shape that is arranged closely to a first conductor layer in a manner approximately parallel therewith, a second conductor that is arranged to face the first conductor in a manner approximately parallel therewith, and a dielectric that is arranged between the first conductor and the second conductor.

The electromagnetic wave interface device shown in Patent Document 3 performs input and output of electromagnetic waves with a sheet-shaped electromagnetic wave transmission medium that has a mesh-like conductor layer. This electromagnetic wave interface device radiates electromagnetic waves within the sheet-shaped electromagnetic wave transmission medium via a conductor plate that is arranged facing the mesh-like conductor layer side.

Non-patent Document 1 discloses a principle of electrical power communication on a sheet-shaped communication medium.

### PRIOR ART DOCUMENTS

### Patent Documents

[Patent Document 1] Japanese Unexamined Patent Application, First Publication No. 2008-295176

[Patent Document 2] Japanese Unexamined Patent Application, First Publication No. 2010-93446

[Patent Document 3] Japanese Unexamined Patent Application, First Publication

No. 2010-136135

### Non-Patent Document

[Non-Patent Document 1] Hiroyuki Shinoda, “High Speed Sensor Network Formed on Material Surfaces,” Journal of the Society of Instrument and Control Engineers, February 2007, Vol. 46, No. 2, pp. 98-103.

### SUMMARY OF THE INVENTION

### Problem to be Solved by the Invention

There are the following problems in surface communication as it stands now.

Generally, the electrical power transmission efficiency, that is, the communication performance, between a power supplying device and a power receiving device depends on the electrical power transmission efficiency between the power supplying device and the sheet-shaped communication medium, and between the sheet-shaped communication medium and the power receiving device.

A conductive coupling element is mounted in the power supplying device or the power receiving device so as to be sandwiched by the reference ground thereof and the communication medium. This conductive coupling element is designed so that the transported amount of electrical power increases due to its resonating at a specified frequency.

Ideally, in the case of a power supplying device, all of the electrical power that is supplied from the power supplying device should be able to be fed to the sheet-shaped communication medium. However, in reality the electromagnetic coupling between the power supplying device and the sheet-shaped communication medium becomes insufficient, and a portion of the electrical power leaks out to the outside as electromagnetic waves. A primary factor of that insufficient electromagnetic coupling is considered to be a large portion of the electromagnetic field surrounding the plate-shaped conductive coupling element being concentrated between the reference ground of the power supplying device and the conductive coupling element.

In the case of the power receiving device, all of the electrical power that is received by the power receiving device should be able to be received from the sheet-shaped communication medium. However, in reality the electromagnetic coupling becomes insufficient, and it either remains on the sheet side as electromagnetic waves without being received, or leaks out to the outside as electromagnetic waves from the gap between the power receiving device and the sheet-shaped communication medium. One factor of that insufficient electromagnetic coupling is considered to be a large portion of the electromagnetic field surrounding the plate-shaped conductive coupling element being concentrated between the reference ground of the power receiving device and the conductive coupling element. As a result, the communication performance falls. For that reason, a structure is desired for strengthening the electromagnetic coupling of the power supplying device or the power receiving device with respect to a sheet-shaped medium.

Moreover, it is desired to reduce the size of the power supplying device or the power receiving device as much as possible. There is a definite relationship between the conductive coupling element and the resonant frequency thereof, and so generally as the conductive coupling element is reduced in size, the resonant frequency increases. This relationship causes difficulties in miniaturizing a power supplying device and a power receiving device for conveying electrical power at a specified frequency.

### Means for Solving the Problem

An exemplary object of the present invention is providing a surface communication device that can solve the aforementioned issues.

In order to solve the aforementioned issues, a surface communication device according to an exemplary aspect of the present invention includes: a sheet-shaped electromagnetic wave propagation unit that propagates electromagnetic waves; and a power supplying device unit or a power receiving device unit that is disposed above the electromagnetic wave propagation unit in a non-conductive state with the electromagnetic wave propagation unit, and includes an electromagnetic wave coupling unit that transmits electromagnetic waves to the electromagnetic wave propagation unit or receives electromagnetic waves from the electromagnetic wave propagation unit. The electromagnetic wave coupling unit includes a dielectric resonator that strengthens an electromagnetic coupling between the electromagnetic wave coupling unit and the electromagnetic wave propagation unit.

### Effect of the Invention

According to the present invention, a dielectric resonator is included in at least one of the electromagnetic wave coupling units of the power supplying device unit and the power receiving device unit that are provided in a non-conductive state with an electromagnetic wave propagation unit. By this dielectric resonator, the electromagnetic coupling between the electromagnetic wave propagation unit that serves as a communication medium and the electromagnetic wave coupling unit is strengthened. As a result, it is possible to improve the communication performance of the surface communication device.

### BRIEF DESCRIPTION OF THE DRAWINGS

FIG. 1 is a frontal cross-sectional view that shows a surface communication device according to one exemplary embodiment of the present invention.

FIG. 2 is a plan view of a mesh layer of an electromagnetic wave propagation sheet shown in FIG. 1.

FIG. 3 is a frontal cross-sectional view that shows the vicinity of a power supplying device unit shown in FIG. 1.

FIG. 4A is a perspective view that shows an example in which a dielectric resonator shown in FIG. 3 has a rectangular shape.

FIG. 4B is a perspective view that shows an example in which the dielectric resonator shown in FIG. 3 has a columnar shape.

FIG. 4C is a perspective view that shows an example in which the dielectric resonator shown in FIG. 3 has a hemispheric shape.

FIG. 4D is a perspective view that shows an example in which the dielectric resonator shown in FIG. 3 has a semi-columnar shape.

FIG. 4E is a perspective view that shows an example in which the dielectric resonator shown in FIG. 3 has a cylindrical shape.

FIG. 4F is a perspective view that shows an example in which the dielectric resonator shown in FIG. 3 is constituted by combining two or more of the dielectric resonators shown in FIG. 4A to FIG. 4E.

FIG. 5 is a frontal cross-sectional view that shows Modified Example 1 of the surface communication device of FIG. 1.

FIG. 6 is a frontal cross-sectional view that shows Modified Example 2 of the surface communication device of FIG. 1.

FIG. 7 is a frontal cross-sectional view that shows Modified Example 3 of the surface communication device of FIG. 1.

FIG. 8 is a frontal cross-sectional view that shows Modified Example 4 of the surface communication device of FIG. 1.

### EMBODIMENTS FOR CARRYING OUT THE INVENTION

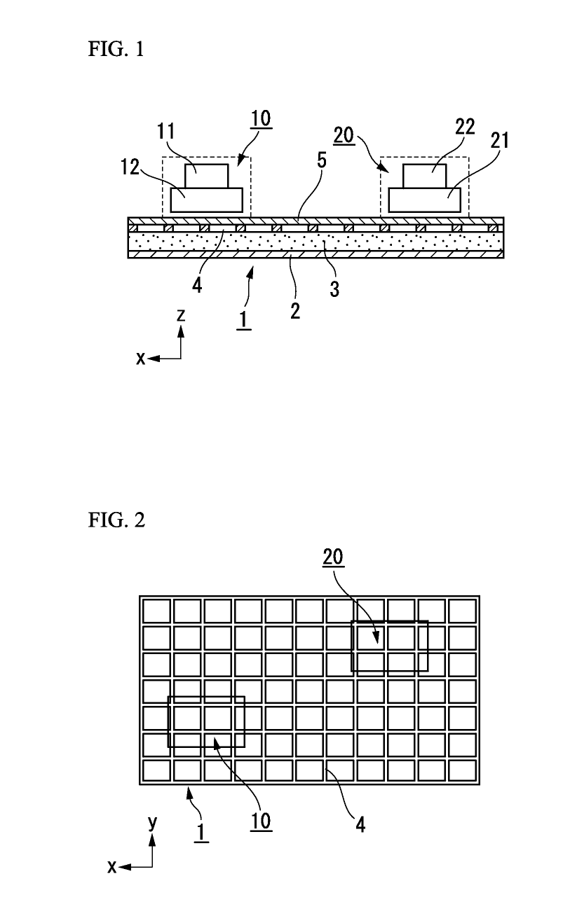

One exemplary embodiment of the present invention shall be described with reference to FIG. 1 to FIG. 7.

FIG. 1 is a front cross-sectional view that shows the structure of a surface communication device according to the present exemplary embodiment. The surface communication device has an electromagnetic wave propagation sheet 1 that serves as an electromagnetic wave propagation unit that serves as the communication medium.

The electromagnetic wave propagation sheet 1 is a constitution in which an electromagnetic wave propagation layer 3, a mesh layer 4, and an insulation layer 5 are laminated in sequence on a conductive plane layer 2. Electromagnetic waves that are supplied from a power supplying device unit 10 (described below) that is installed on the upper surface of the electromagnetic wave propagation sheet 1 are propagated in a direction along the sheet surface of the electromagnetic wave propagation sheet 1, and thereafter received by a power receiving device unit 20 (described below).

FIG. 2 is a plan view that shows the mesh layer 4 of the electromagnetic wave propagation sheet 1. As shown in FIG. 2, the mesh layer 4 is a conductor that is formed in a mesh shape. The electromagnetic wave propagation layer 3 is a space that is sandwiched by the mesh layer 4 and the conductive plane layer 2. Electromagnetic waves are propagated in a direction along the surface of the sheet within this space.

The insulation layer 5 is provided so that the power supplying device unit 10 or the power receiving device unit 20, and the electromagnetic wave propagation layer 3 are not mutually conductive. The medium of the insulation layer 5 is a medium that has a specified permittivity and magnetic permeability, and does not pass direct current. As the medium material of the insulation layer 5, air or a vacuum is included.

The power supplying device unit 10 that serves as the electromagnetic wave transmitting unit and the power receiving device unit 20 that serves as the electromagnetic wave receiving unit are installed as shown in FIG. 1 on the upper surface of the electromagnetic wave propagation sheet 1.

The power supplying device unit 10 and the power receiving device unit 20 can be installed in a plurality on the electromagnetic wave propagation sheet 1. Also, the power supplying device unit 10 and the power receiving device unit 20 may be detachably provided on the electromagnetic wave propagation sheet 1.

The power supplying device unit 10 and the power receiving device unit 20 are provided at arbitrary locations on the electromagnetic wave propagation sheet 1 in a non-conductive state with no conductor contact via the insulation layer 5 within the electromagnetic wave propagation sheet 1. Here, a sheet shape means one that has a surficial spread and thin thickness, such as a cloth shape, a paper shape, a foil shape, a plate shape, a membrane shape, a film shape, or a mesh shape.

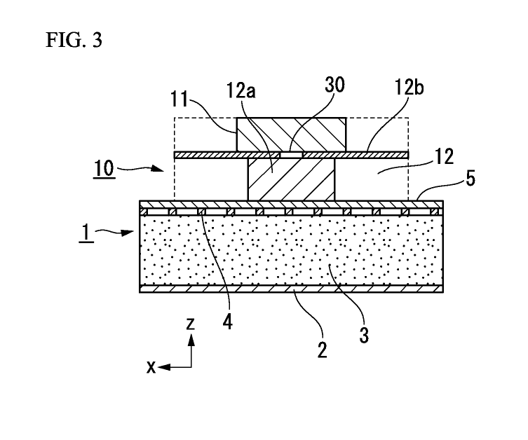

The power supplying device unit 10 includes an electromagnetic wave generating unit 11 and a transmission electromagnetic wave coupling unit 12, as shown in FIG. 1 and FIG. 3. The power supplying device unit 10 is arranged in an opposing positional relationship with respect to the electromagnetic wave propagation sheet 1.

The transmission electromagnetic wave coupling unit 12 includes a dielectric resonator 12a and a reference conductor 12b. The dielectric resonator 12a is disposed in an opposing positional relationship with respect to the electromagnetic wave propagation sheet 1. The dielectric resonator 12a pumps electromagnetic waves generated by the electromagnetic wave generating unit 11 into the electromagnetic wave propagation layer 3 via the mesh layer 4. The reference conductor 12b is disposed so as to make contact with the main body unit of the dielectric resonator 12a.

By providing the dielectric resonator 12a in the transmission electromagnetic wave coupling unit 12, electromagnetic coupling between the electromagnetic wave propagation sheet 1 that serves as a communication medium and the electromagnetic wave coupling unit 12 is strengthened. As a result, the communication performance of a surface communication device is improved.

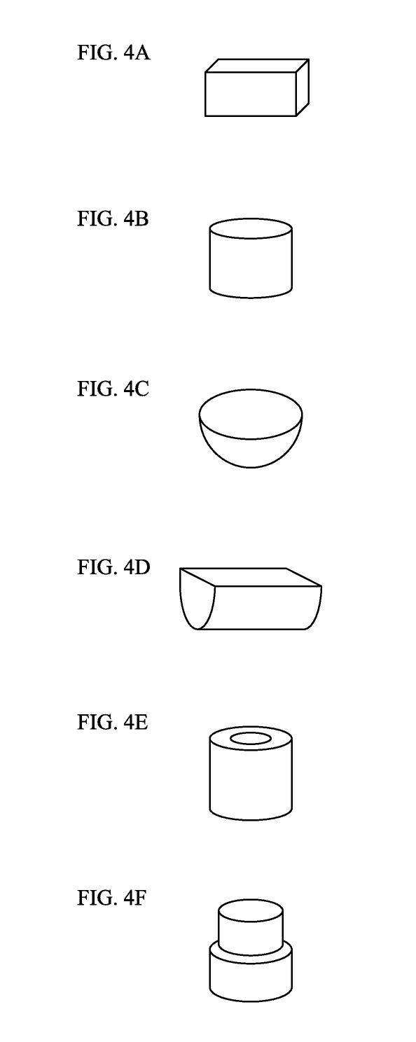

The dielectric resonator 12a of the transmission electromagnetic wave coupling unit 12 can be made to have various shapes. For example, the dielectric resonator 12a may be rectangular as shown in FIG. 4A. The dielectric resonator 12a may have a columnar shape as shown in FIG. 4B. The dielectric resonator 12a may have a hemispheric shape as shown in FIG. 4C. The dielectric resonator 12a may have a semi-columnar shape as shown in FIG. 4D. The dielectric resonator 12a may have a cylindrical shape as shown in FIG. 4E.

The conceivable structure of the dielectric resonator 12a is not limited to the aforementioned, with various modified structures and combinations thereof being possible. As shown in FIG. 4F, the dielectric resonator 12a may be formed by combining two or more of the shapes shown in FIG. 4A to FIG. 4E (in this example, the dielectric resonator 12a is a structure in which two types of cylindrical shapes having the same shaft center are superimposed).

Generally, a high dielectric material having a relative permittivity of 10 or more is used for the dielectric resonator 12a. The resonant frequency of the dielectric resonator 12a that has a high dielectric material as its material is lower than a coupling element with a conductor shape that has an equivalent surface area and dimensions. Accordingly, a reduction in size of the conductive element is possible. Simultaneously with this, since the dielectric resonator 12a faces the insulation layer 5 without interposing the conductor plane 2, when it resonates, the electromagnetic waves directly seep out to the communication medium side.

That is to say, in the present exemplary embodiment, the region in which the resonating electromagnetic field distribution is in contact with the communication medium increases compared with the case of using a plate-shaped conductor as the conductive coupling element. As a result, the electromagnetic coupling between the electromagnetic wave coupling unit and the communication medium is strengthened.

Also, an opening 30 is formed in the reference conductor 12b between the electromagnetic wave generating unit 11 and the transmission electromagnetic wave coupling unit 12 (dielectric resonator 12a). This opening 30 is provided in order to facilitate transmission of the electromagnetic waves generated by the electromagnetic wave generating unit 11 to the transmission electromagnetic wave coupling unit 12. Modified examples relating to the structure in the vicinity of this opening 30 shall be described subsequently.

Next, the power receiving device unit 20 that receives the electromagnetic waves that have been output from the power supplying device unit 10 and that have propagated through the electromagnetic wave propagation sheet 1 shall be described.

The power receiving device unit 20 is constituted from a reception electromagnetic wave coupling unit 21 that receives electromagnetic waves that propagate through the electromagnetic wave propagation sheet 1, and an electromagnetic wave input unit 22 to which the received electromagnetic waves is input. The reception electromagnetic wave coupling unit 21 basically is a constitution that has a dielectric resonator 12a and a reference conductor 12b, in the same manner as the transmission electromagnetic wave coupling unit 12 of the aforementioned power supplying device unit 10. For this reason, overlapping descriptions on the reception electromagnetic wave coupling unit 21 shall be omitted. That is to say, in the case of supplying electrical power, electromagnetic waves are pumped to the electromagnetic wave propagation sheet 1, but in the case of receiving electrical power, conversely electromagnetic waves propagated by the electromagnetic wave propagation sheet 1 are received.

According to the exemplary embodiment of the present invention as described in detail hereinabove, the dielectric resonator 12a is included in the transmission electromagnetic wave coupling unit 12 of the power supplying device unit 10, and the reception electromagnetic wave coupling unit 21 of the power receiving device unit 20. By this dielectric resonator 12a, the electromagnetic coupling between the electromagnetic wave propagation sheet 1 that serves as the communication medium and the power supplying device unit 10 and power receiving device unit 20 is strengthened. As a result, it is possible to improve the communication performance of the surface communication device.

Moreover, according to the present invention, a high dielectric material having a relative permittivity of 10 or more is used as the dielectric resonator 12a. For this reason, the resonant frequency of the dielectric resonator 12a is lower than a coupling element with a conductor shape that has an equivalent surface area and dimensions. Accordingly, a reduction in size of the electromagnetic wave coupling units 12 and 21 is possible.

Simultaneously with this, the dielectric resonator 12a faces the insulation layer 5 on the electromagnetic wave propagation sheet 1 without interposing a conductor plane. For this reason, when it resonates, the electromagnetic waves directly seep out to the communication medium side. That is to say, according to the exemplary embodiment of the present invention, the region in which the resonating electromagnetic field distribution is in contact with the communication medium increases compared with the case of using a plate-shaped conductor as the conductive coupling element. As a result, the electromagnetic coupling between the electromagnetic wave coupling unit and the communication medium is strengthened.

In the exemplary embodiment of the present invention, FIG. 2 shows an example in which the shape of the openings in the mesh layer 4 of the electromagnetic wave propagation sheet 1 is rectangular. However, the shape of the openings of the mesh layer 4 is not limited to rectangular. Provided the openings of the mesh layer 4 have a structure that can be applied as an electromagnetic wave propagation sheet 1, modifications to various shapes is possible. For example, the opening may be hexagonal, may be triangular, or may be circular.

In the exemplary embodiment of the present invention, the opening 30 is formed in the reference conductor 12b between the electromagnetic wave generating unit 11 and the transmission electromagnetic wave coupling unit 12 in order to facilitate transmission of the electromagnetic waves generated by the electromagnetic wave generating unit 11 to the transmission electromagnetic wave coupling unit 12. However, it is not limited to this constitution, and may be constituted as shown in modified examples 1 to 3 below.

### MODIFIED EXAMPLE 1

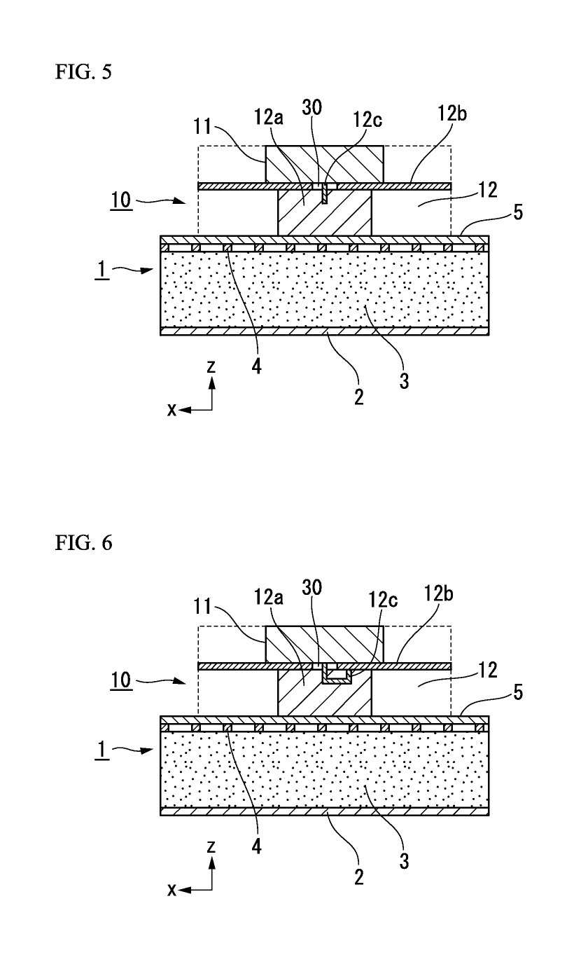

As shown in FIG. 5, a conductor piece 12 for matching may be provided in the opening 30 of the transmission electromagnetic wave coupling unit 12. Forming this conductor piece 12 in a bar shape facilitates the electric field coupling with the dielectric resonator 12a. Accordingly, due to the relationship with the electromagnetic field mode of the corresponding dielectric resonator 12a, by disposing the aforementioned bar-shaped conductor piece 12a at a location where the electrical field is comparatively strong, it is possible to strengthen the electromagnetic coupling between the electromagnetic wave coupling unit 12 of the power supplying device unit 10 and the electromagnetic wave coupling unit 21 of the power receiving device unit 20, and the electromagnetic wave propagation sheet 1.

### MODIFIED EXAMPLE 2

As shown in FIG. 6, the conductor piece 12c that is shown in Modified Example 1 may be formed in a loop shape, and the conductor piece 12c may be connected to ground at the reference conductor 12b. Forming the conductor piece 12c in a loop shape facilitates the electromagnetic coupling with the dielectric resonator 12a. Accordingly, due to the relationship with the electromagnetic field mode of the corresponding dielectric resonator 12a, by disposing the aforementioned loop-shaped conductor piece 12a at a location where the magnetic field is comparatively strong, it is possible to strengthen the electromagnetic coupling between the electromagnetic wave coupling unit 12 of the power supplying device unit 10 and the electromagnetic wave coupling unit 21 of the power receiving device unit 20, and the electromagnetic wave propagation sheet 1.

### MODIFIED EXAMPLE 3

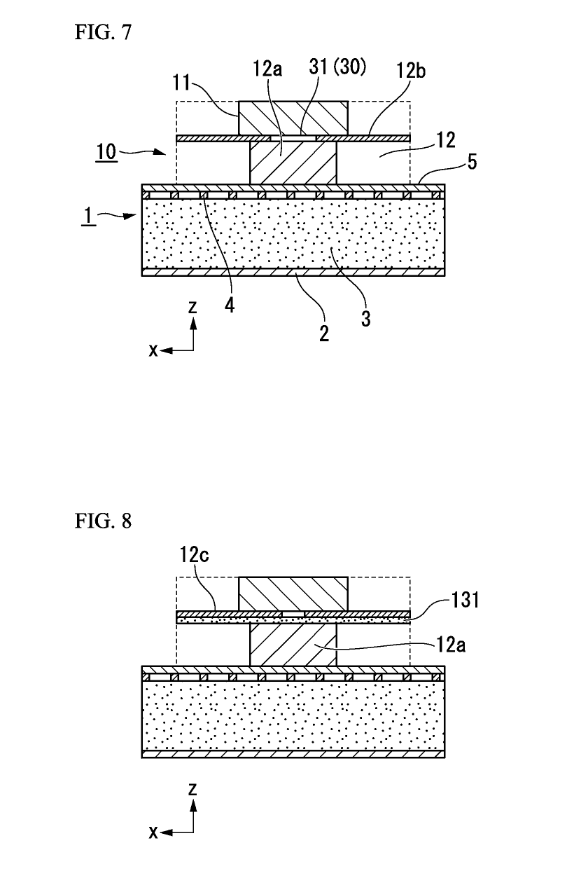

As shown in FIG. 7, without using the conductor piece 12c, instead of that the opening 30 may be made into a wide slit 31. Adopting this kind of slit structure facilitates the electromagnetic coupling of the electromagnetic waves that propagate through the slit 31 with the dielectric resonator 12a. Thereby, it becomes possible to strengthen the electromagnetic coupling between the electromagnetic wave coupling unit 12 of the power supplying device unit 10 and the electromagnetic wave coupling unit 21 of the power receiving device unit 20, and the electromagnetic wave propagation sheet 1.

FIGS. 3 and 5 to 7 of the exemplary embodiment of the present invention shows examples of the dielectric resonator 12a and the reference conductor 12b being in contact, but they need not necessarily be in contact. For example, as shown in FIG. 8, an insulation layer 131 may be provided between the dielectric resonator 12a and the reference conductor 12b.

The surface communication device of the present invention is not limited to the aforementioned exemplary embodiment that is described referring to the drawings, with various modified examples being conceivable within the technical scope thereof. For example, various modified examples are possible to combinations of the constituent elements or processes thereof given in the aforementioned exemplary embodiment.

Specifically, in the aforementioned exemplary embodiment, both of the power supplying device unit 10 and the power receiving device unit 20 are provided, but either one only may be provided. For example in the case of only the power supplying device unit 10 being provided, electromagnetic waves that are supplied to the power receiving device unit 20 may be performed by contact power supply. In the case of only the power receiving device unit 20 being provided, electromagnetic waves that are supplied to the power supplying device unit 10 may be performed by contact power supply. In the present exemplary embodiment, both the power supplying device unit 10 and the power receiving device unit 20 are provided, but a device unit on the side that employs contact power supply, by being added in a separate process, may be removed from the constituent elements.

The exemplary embodiment of the present invention can be used as a surface communication device with the object of propagating electrical power as energy from the power supplying device side to the power receiving device side, and simultaneously can be used as a surface communication device with the object of propagating electrical power as communication data from the power supplying device side to the power receiving device side.

For example, it can also be used with the object of mounting a plurality of pairs of power supplying devices and power receiving devices on the electromagnetic wave propagation sheet 1, and propagating electrical power as energy by some of the pairs of power supplying devices and power receiving devices, and propagating electrical power as communication as data from the power supplying device side to the power receiving device side with the remaining pairs of power supplying devices and power receiving devices.

In the foregoing, through the present invention has been described referring to the exemplary embodiment, the present invention is by no means limited to the afore-described exemplary embodiment. Various modifications in the forms and details of the present invention that could be understood by a person skilled in the art can be made within the scope of the present invention.

### INDUSTRIAL APPLICABILITY

The present invention can be applied to technology for wirelessly supplying electrical power. The present invention in particular can be applied to a surface communication device that supplies power from a power supplying side to a sheet, or supplies electrical power from a sheet to a power receiving side such as a load.

This application is based upon and claims the benefit of priority from Japanese patent application No. 2010-228353, filed Oct. 8, 2010, the disclosure of which is incorporated herein in its entirety by reference.

### REFERENCE SYMBOLS

1 Electromagnetic wave propagation sheet (electromagnetic wave propagation unit)
10 Power supplying device unit
12 Transmission electromagnetic wave coupling unit
12a Dielectric resonator
20 Power receiving device unit
21 Reception electromagnetic wave coupling unit

1. A surface communication device comprising:
a sheet-shaped electromagnetic wave propagation unit that propagates electromagnetic waves; and
a power supplying device unit that is disposed above the electromagnetic wave propagation unit in a non-conductive state with the electromagnetic wave propagation unit, the power supplying device unit including an electromagnetic wave coupling unit that transmits electromagnetic waves to the electromagnetic wave propagation unit,
the electromagnetic wave coupling unit including a dielectric resonator that strengthens an electromagnetic coupling between the electromagnetic wave coupling unit and the electromagnetic wave propagation unit.

2. A surface communication device comprising:
a sheet-shaped electromagnetic wave propagation unit that propagates electromagnetic waves; and
a power receiving device unit that is disposed above the electromagnetic wave propagation unit in a non-conductive state with the electromagnetic wave propagation unit, the power receiving device unit including an electromagnetic wave coupling unit that receives electromagnetic waves from the electromagnetic wave propagation unit,
the electromagnetic wave coupling unit including a dielectric resonator that strengthens an electromagnetic coupling between the electromagnetic wave coupling unit and the electromagnetic wave propagation unit.

3. A surface communication device comprising:
a sheet-shaped electromagnetic wave propagation unit that propagates electromagnetic waves;
a power supplying device unit that is disposed above the electromagnetic wave propagation unit in a non-conductive state with the electromagnetic wave propagation unit, the power supplying device unit including an electromagnetic wave coupling unit that transmits electromagnetic waves to the electromagnetic wave propagation unit; and
a power receiving device unit that is disposed above the electromagnetic wave propagation unit in a non-conductive state with the electromagnetic wave propagation unit, the power receiving device unit including an electromagnetic wave coupling unit that receives electromagnetic waves from the electromagnetic wave propagation unit,
the electromagnetic wave coupling unit of the power supplying device unit including a dielectric resonator that strengthens an electromagnetic coupling between the electromagnetic wave coupling unit and the electromagnetic wave propagation unit, and
the electromagnetic wave coupling unit of the power receiving device unit including a dielectric resonator that strengthens an electromagnetic coupling between the electromagnetic wave coupling unit and the electromagnetic wave propagation unit.

4. The surface communication device according to claim 3, wherein the electromagnetic wave coupling unit further includes a bar-shaped conductor piece.

5. The surface communication device according to claim 3, wherein the electromagnetic wave coupling unit further includes a loop-shaped conductor piece.

6. The surface communication device according to claim 4, wherein the electromagnetic wave coupling unit further includes a reference conductor in which a slit is formed.

7. The surface communication device according to claim 3, wherein the dielectric resonator has a rectangular shape.

8. The surface communication device according to claim 3, wherein the dielectric resonator has a columnar shape.

9. The surface communication device according to claim 3, wherein the dielectric resonator has a hemispherical shape.

10. The surface communication device according to claim 3, wherein the dielectric resonator has a rectangular-columnar shape.
